(19) United States
(12) Patent Application Publication
(10) Pub. No.: US 2013/0181849 A1
(43) Pub. Date: Jul. 18, 2013

(54) LUMINOUS TRAFFIC SIGN PLATE WITH SPEED DETECTING AND WARNING FUNCTION

(71) Applicant: Shuei-Tian CAI, Taichung City (TW)

(72) Inventor: Shuei-Tian CAI, Taichung City (TW)

(73) Assignee: SAFETY TRAFFIC EQUIPMENT CO., LTD., Taichung City (TW)

(21) Appl. No.: 13/352,850

(22) Filed: Jan. 18, 2012

(51) Int. Cl. G08G 1/09

(52) U.S. Cl. 340/905

(57) ABSTRACT

A luminous traffic sign plate with speed detecting and warning function has a vertical polar frame, with a landing end and a functioning section. An indicating plate is fitted on the functioning section and has a marking surface. The marking surface has a traffic sign. An LED lighting unit has a plurality of LED components and conducting wires to connect the LED components. Said LED lighting unit is fitted and distributed on the marking surface so that the traffic sign is in a luminous state. A speed detecting device is fitted on the functioning section and detects the speed of the vehicle from predetermined direction. A warning device generates a warning signal. An electro-control device is for connecting and integrating the LED lighting unit, speed detecting device, and warning device, and to control the lighting state of the LED lighting unit. A power supply device supplies electric power.

CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to a traffic sign plate, and more particularly to an innovative structural design of a luminous traffic sign plate with speed detection and warning functions.

2. Description of Related Art Including Information Disclosed Under 37 CFR 1.97 and 37 CFR 1.98.

In order to enhance traffic safety and reduce traffic accidents, related governmental authorities are setting up various traffic sign plates on roadsides for warning purposes, for example. Typical signs include: Caution Children, Road Narrowing, Danger from Cross-Winds, Consecutive Curve, Slow, Narrow Road, Highest Speed Limit etc.

For a long time, conventional traffic sign plates with printed signs and texts on the surface have indeed provided a warning function to some degree, but they are still passive. With rapid development of related technologies, the functions of traffic sign plates are moving forward from the conventional passive stage to an active stage. A successful example is the introduction of LED lighting technology. The LED provides stable and good visibility of the signs and texts of the traffic sign plates, avoiding the adverse influence of night darkness and bad weather upon the traffic sign plates, without the need to consume a lot of energy or to expand the installation size. Hence, currently there is an increasing trend for LED traffic sign plates to widely replace the conventional traffic sign plates.

Thus, to overcome the aforementioned problems of the prior art, it would be an advancement if the art to provide an improved structure that can significantly improve the efficacy.

Therefore, the inventor has provided the present invention of practicability after deliberate design and evaluation based on years of experience in the production, development and design of related products.

### BRIEF SUMMARY OF THE INVENTION

The present invention features an innovative and unique structural design with a vertical frame, an LED lighting unit, a speed detecting device, a warning device, an electro-control device and a power supply device. Compared to the known technique of the prior art, the present invention can enable the luminous traffic sign plate to automatically detect the speed of the coming vehicle, and if the coming vehicle is speeding, the warning device will emit sudden flashing lights or change the warning message, which will stimulate the brains of the passers-by to generate a reflection of the warning signal, and consequently, the warning will be intensified and traffic safety enhanced.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 is a perspective view of the preferred embodiment of the present invention.

FIG. 2 is a partial enlarged view of the LED lighting unit of the present invention.

FIG. 3 is a plan enlarged sectional view of the LED lighting unit of the present invention attached to the marking surface of the indicating plate.

FIG. 4 is a schematic view of an embodiment of the electro-control device of the present invention controlling the warning device to generate a warning signal according to the speed detected by the speed detecting device.

FIG. 5 is a schematic view of an embodiment of the warning device of the present invention being a dynamic message sign displayer.

FIG. 6 is a schematic view of an embodiment of the auxiliary sensor of the present invention being a wind speed sensor.

FIG. 7 is a text-box flow-chart of the present invention.

FIG. 8 is a schematic view of an embodiment of the wireless transmission module of the present invention applied at a T junction.

FIG. 9 is an enlarged schematic view of Part B of FIG. 8.

### DETAILED DESCRIPTION OF THE INVENTION

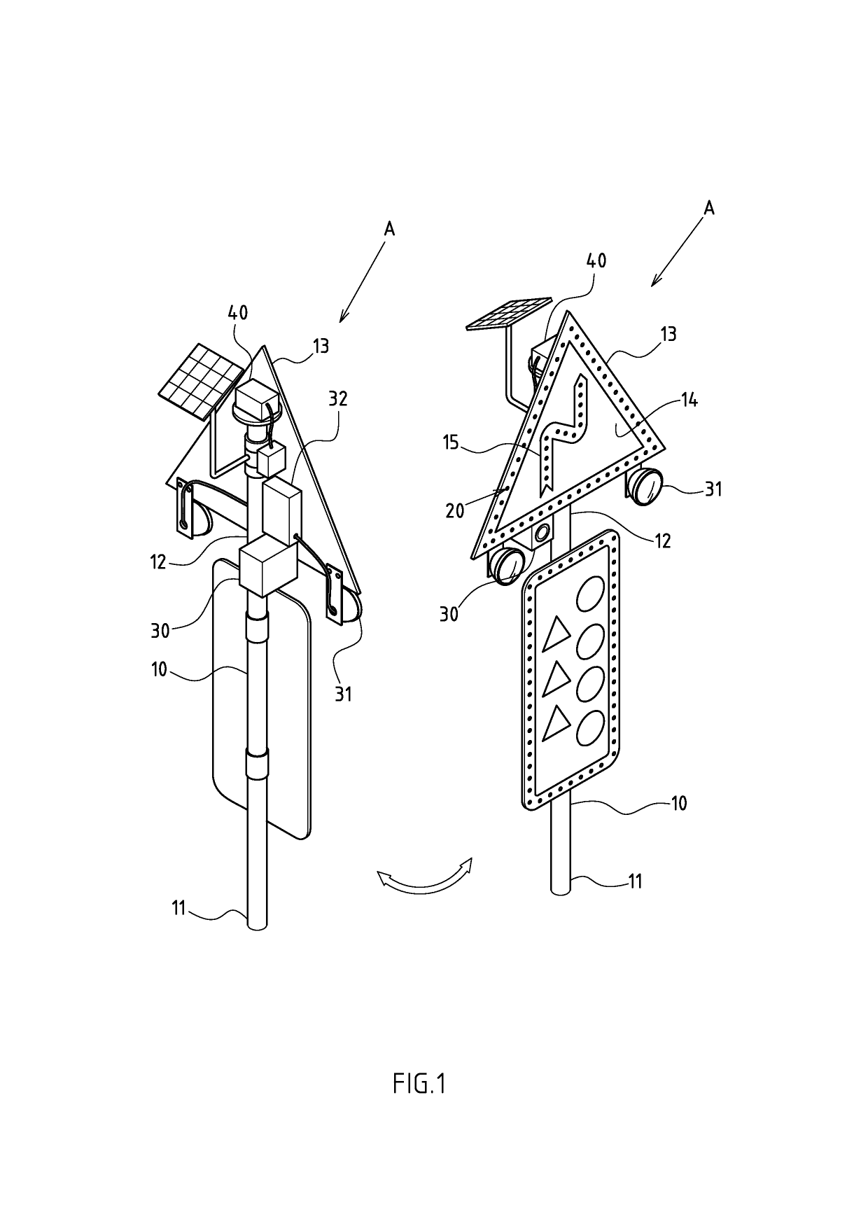

FIGS. 1 to 6 depict a preferred embodiment of the luminous traffic sign plate with speed detecting and warning function of the present invention. However, this embodiment is illustrative only, and shall not intend to be limiting to the scope of patent application.

Said luminous traffic sign plate A comprises a vertical frame 10, being a vertical polar frame, with a landing end 11 and a functioning section 12.

At least one indicating plate 13 is fitted on the functioning section 12 of the vertical frame 10. Said indicating plate 13 has a marking surface 14, and the marking surface 14 has a traffic sign 15.

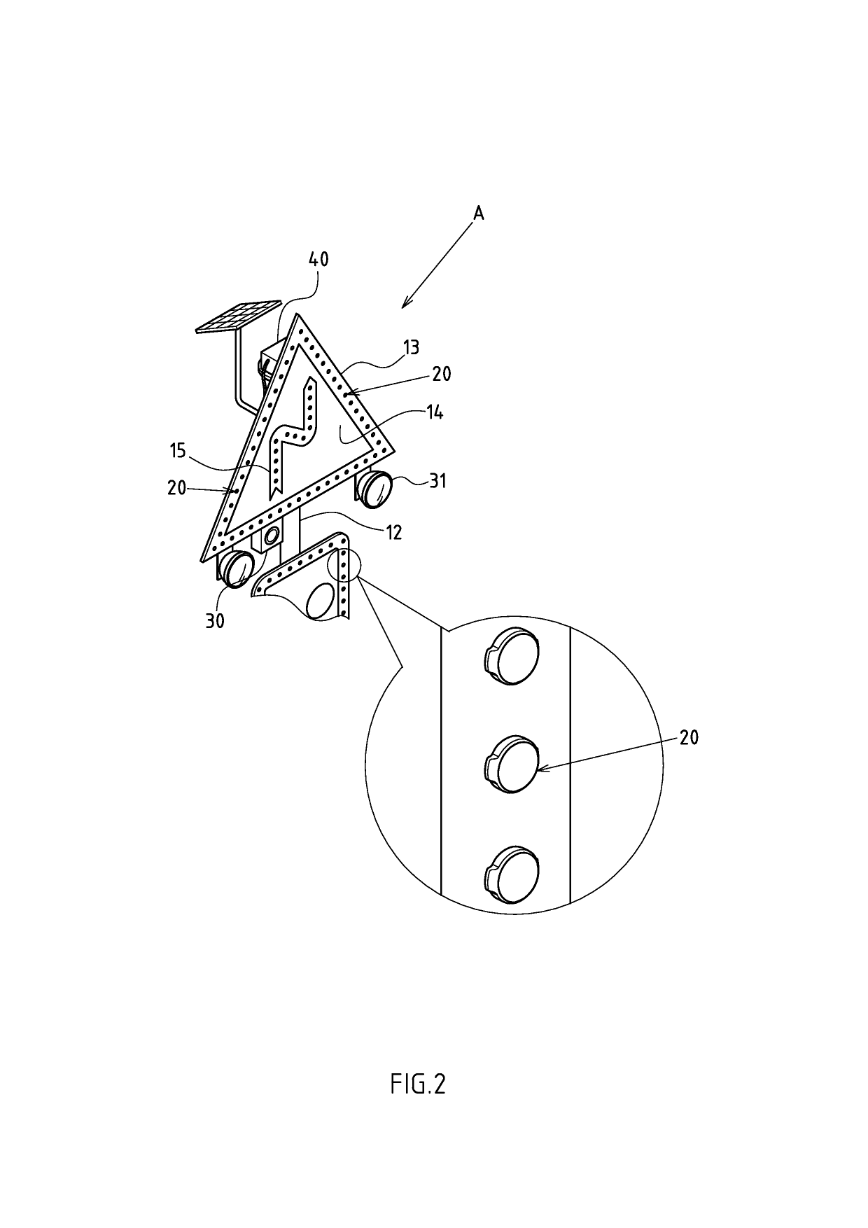

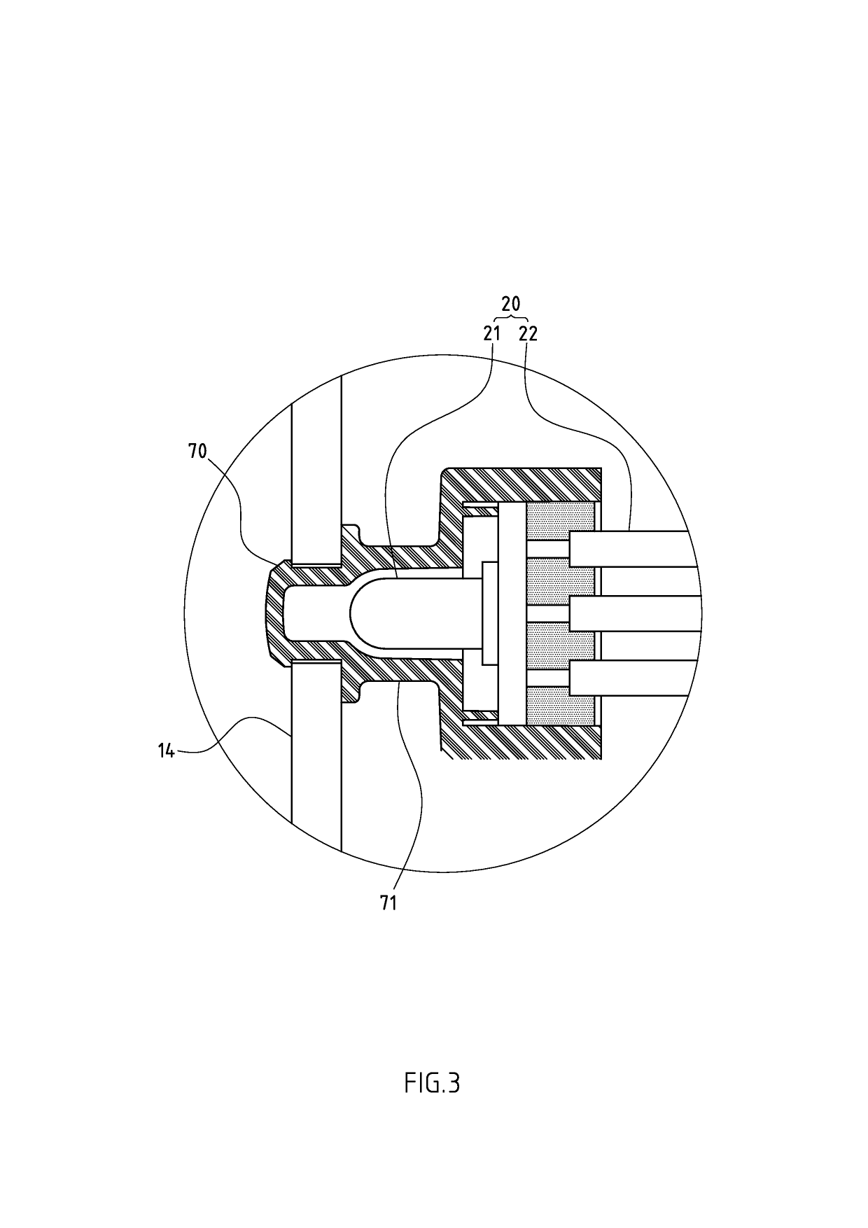

An LED lighting unit 20 is provided, as shown in FIGS. 2 and 3, comprising a plurality of LED components 21 and conducting wires 22 to connect the LED components 21. Said LED lighting unit 20 is fitted and distributed on the marking surface 14 of the indicating plate 13, so that the traffic sign 15 is in a luminous state. The surface of the LED lighting unit 20 can be covered with waterproof material (for example, waterproof transparent glue), so that the LED components 21 and conducting wires 22 will not get wet and damaged, or their lifecycle reduced.

A speed detecting device 30 is fitted on the functioning section 12 of the vertical frame 10. Said speed detecting device 30 will detect the speed of the vehicle from predetermined direction. The speed detecting device 30 can be a speed detecting structure of any kind: induction coil; radar; or laser.

A warning device 31 is provided to generate a preset style of warning signal. The warning device 31 can be any structure of a flashing warning lamp, an illumination lamp, a dynamic message sign displayer, a controllable LED indicating plate, or an alarm. As the passers-by are already accustomed to the existence of various conventional traffic sign plates, their warning function is weakened. Hence, if the warning device 31 can flash or change the warning messages, it will stimulate the brains of the passers-by to generate a reflection of the warning signal, and consequently, the warning will be intensified and traffic safety enhanced.

An electro-control device 32 (only marked in FIG. 1) is fitted on the functioning section 12 of the vertical frame 10, connecting and integrating the LED lighting unit 20, speed detecting device 30, and warning device 31, to control the lighting state of the LED lighting unit 20, and control the warning device 31 to automatically generate a preset warning signal based on the speed detected by the speed detecting device 30.

A power supply device 40 is electrically connected to the LED lighting unit 20, speed detecting device 30, warning device 31, and the electro-control device 32, to supply electric power for overall functioning. The power supply device 40 can be any kind of power supply: cells, municipal electricity, or cells combined with solar power photovoltaie panel. FIG. 1 depicts an embodiment of the power supply device 40 being cells combined with a solar power photovoltaie panel.

Referring to FIG. 3, the LED lighting unit 20 can be fitted on the marking surface 14 of the indicating plate 13 through an inlaying part 70. And the LED components 21 are fitted inside the waterproof transparent enclosure 71. Other LED lighting components are prior art and are not detailed here.

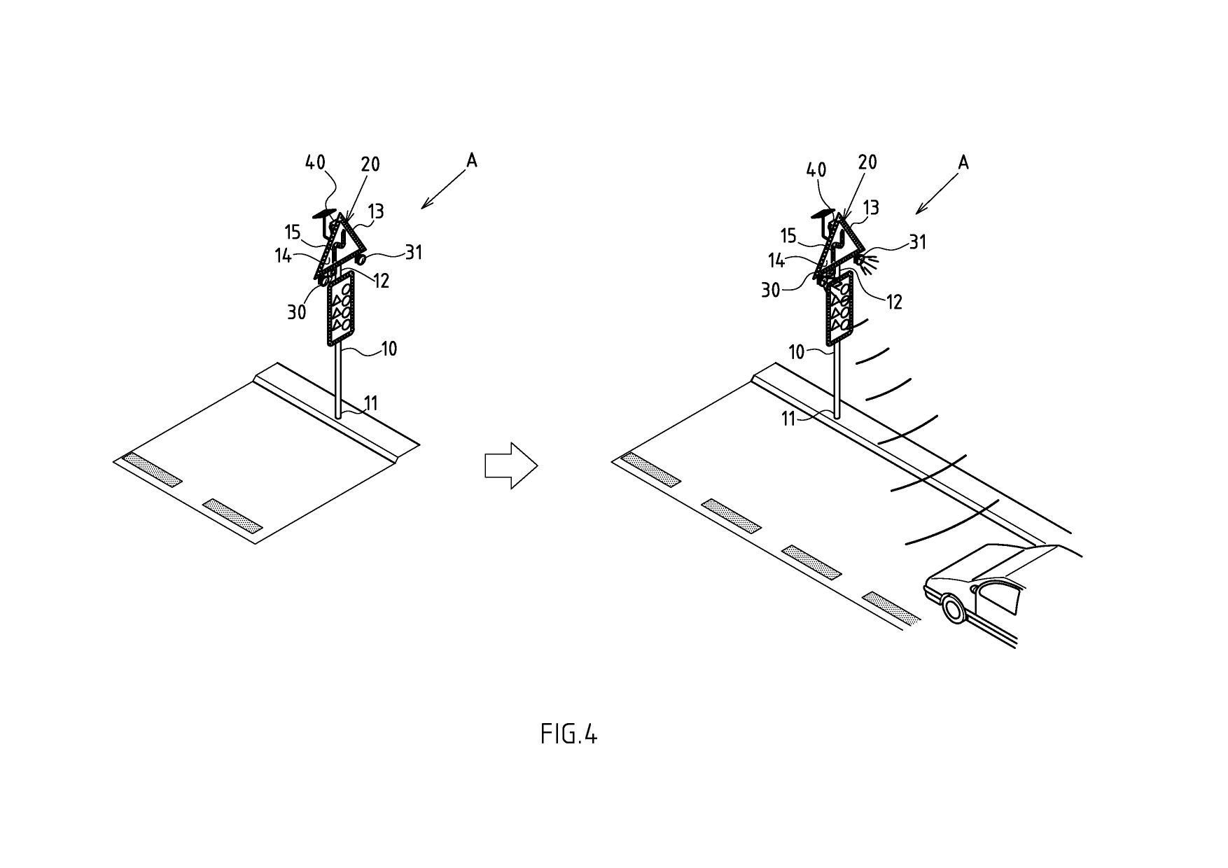

Referring to FIG. 4, the speed detecting device 30 can be preset with a speed standard (for example, 50 kilometers). If the speed exceeds this standard, the electro-control device 32 will control the warning device 31 to emit a warning signal (for example, the warning device 31 in this embodiment is a flashing warning lamp, it will flash to remind the passers-by to reduce the speed). The warning device 31 will function only when the vehicle is detected by the speed detecting device 30 to be exceeding the speed limit. Hence, it is energy-saving.

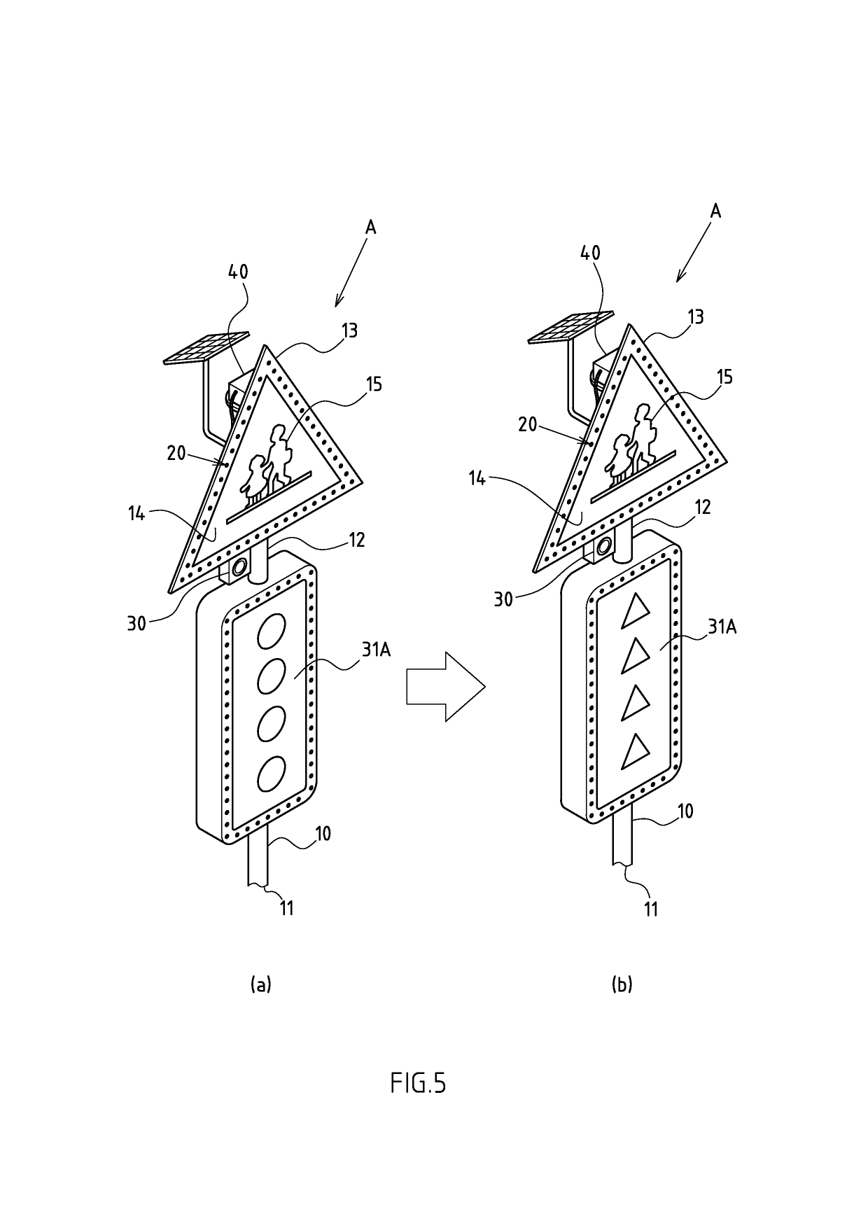

Referring to FIG. 5, the warning device 31 of the present invention is a dynamic message sign displayer 31A. When there is no over-speed situation, the dynamic message sign displayer 31A will show a warning message corresponding to the traffic sign 15 (as shown in FIG. a). If the speed detecting device 30 detects an over-speed situation of the coming vehicle, the dynamic message sign displayer 31A will change the original message, and show an alarming message to warn the speeding vehicle (as shown in FIG. b). Due to the multiple warnings from the same facility, the space occupation and cost of traffic sign plates can be considerably reduced.

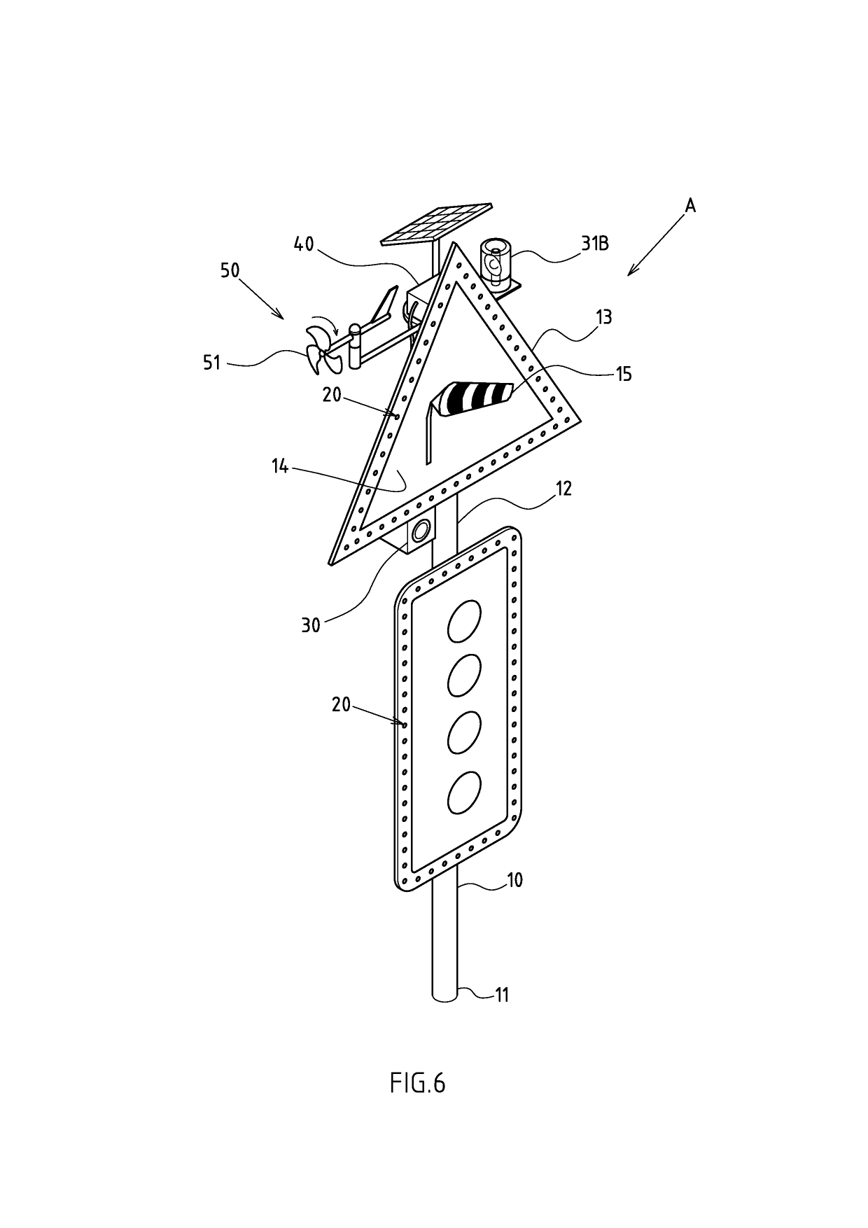

The functioning section 12 of the vertical frame 10 is configured with an auxiliary sensor 50, which is electrically connected to the electro-control device 32. The auxiliary sensor 50 can detect a preset environmental state as the requisite for the speed detecting device 30 to execute the speed detection of the coming vehicle. Referring to FIG. 6, the auxiliary sensor 50 is a wind speed sensor 51, and the warning device 31 is an alarm 31B. The wind speed sensor 51 can also be set with a wind speed standard (for example, Grade 3 wind). When the wind speed sensor 51 detects an excess of the prescribed standard of wind speed, the electro-control device 32 will control the alarm 31B to emit flashing lights and warning sounds so as to remind the passers-by to reduce their speed.

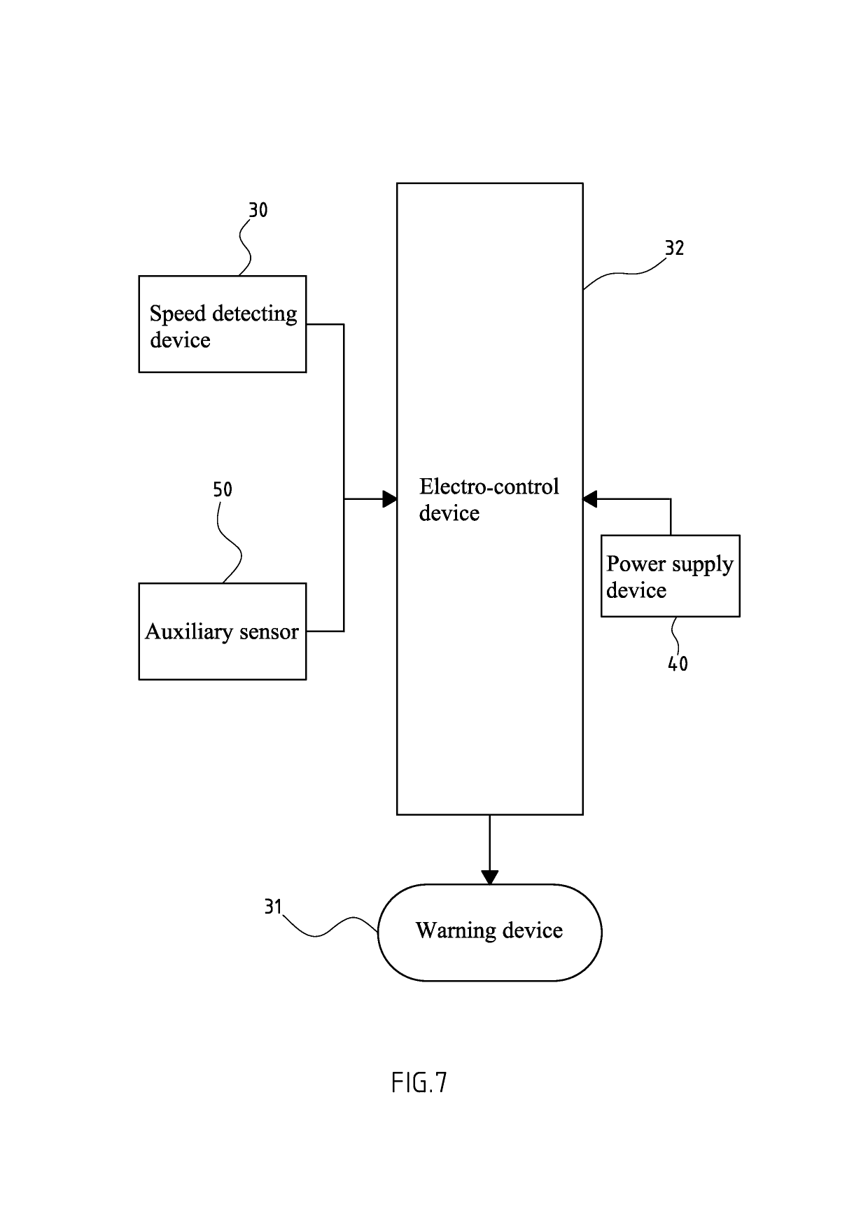

FIG. 7 is a text-box flow chart of the present invention. A power supply device 40 supplies electric power to the electro-control device 32 for determination of the start of the warning device 31 based on the situation detected by the speed detecting device 30 and the auxiliary sensor 50.

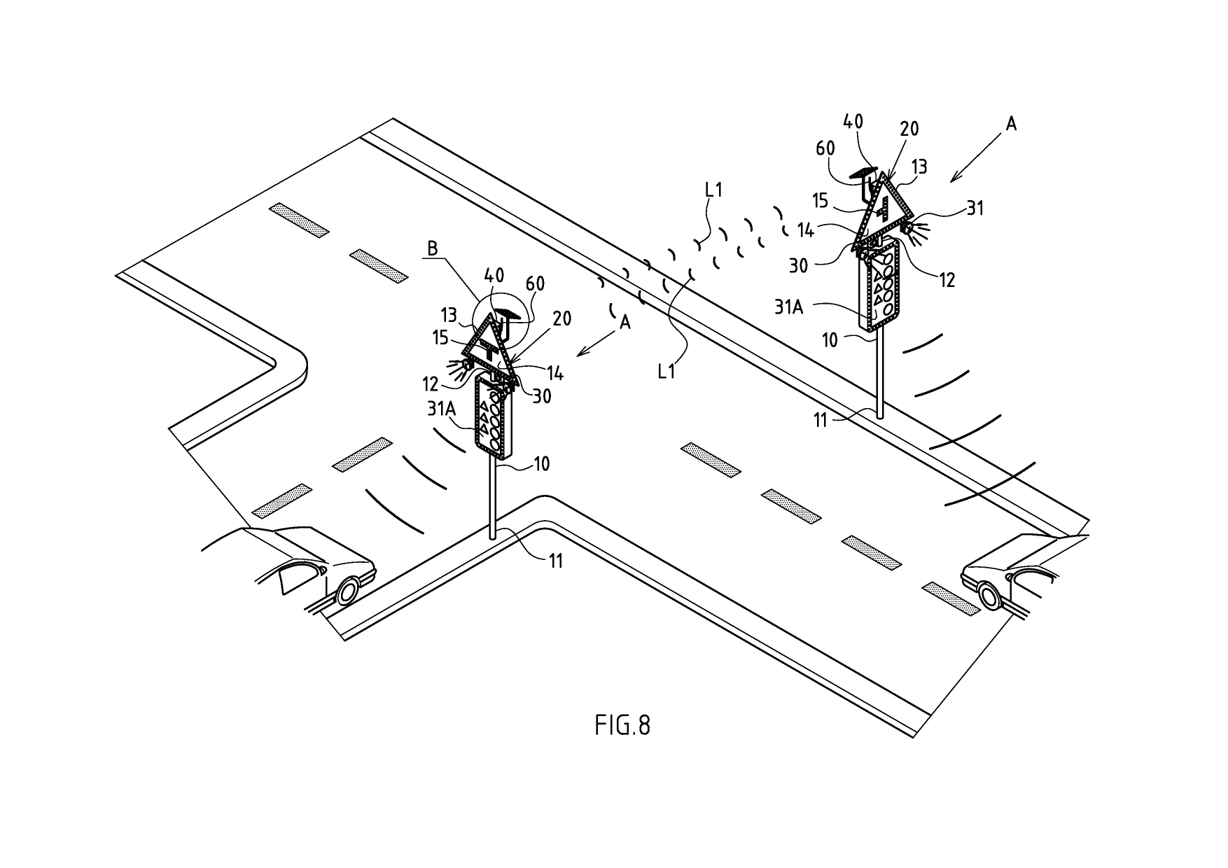

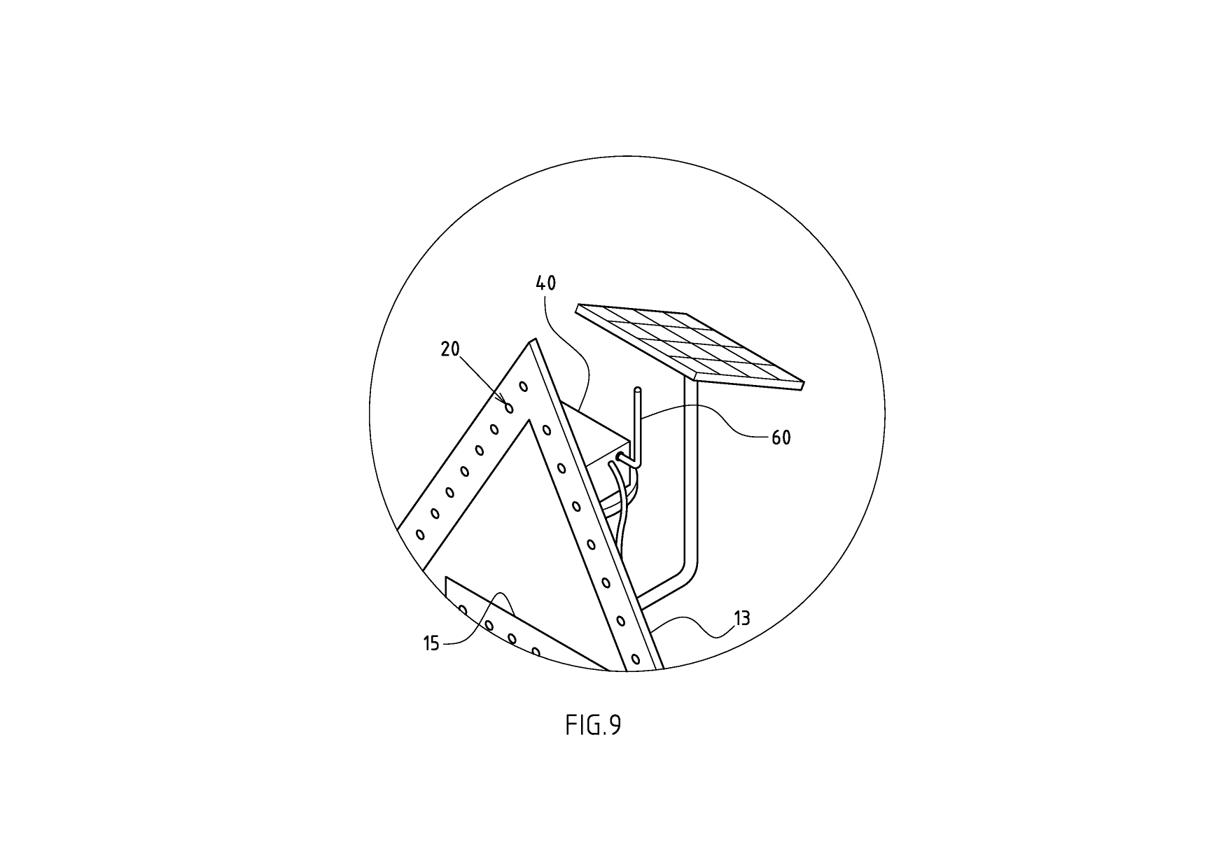

Referring to FIG. 8, the luminous traffic sign plate A can also comprise a wireless transmission module 60 (see detail in FIG. 9). The wireless transmission module 60 and the electro-control device 32 (marked in FIG. 1) are electrically connected. When the speed detecting device 30 detects a coming vehicle or the coming vehicle is speeding, the electro-control device 32 will activate the wireless transmission module 60 to transmit a signal (as indicated by L1) to a remote wireless transmission module 60 installed on another luminous traffic sign plate A, so that the warning device 31 on this luminous traffic sign plate A will generate a preset warning signal. The embodiment of this structure can be applied in various traffic environments. FIG. 8 shows an implementation at a T-junction. With the addition of a wireless transmission module 60, when the driver approaches the T-junction, if there is an approaching vehicle from the crossing road, the warning device 31 (for example, a dynamic message sign displayer 31A as shown in the drawing) will display a warning message. Moreover, this embodiment can also be applied in other traffic environments like gate way, ramp, one-way street etc for more active and effective traffic warning.

I claim:

1. A luminous traffic sign plate with speed detecting and warning function, comprising:
a vertical frame, being a vertical polar frame, with a landing end and a functioning section;
at least one indicating plate, fitted on the functioning section of the vertical frame, said indicating plate has a marking surface, and the marking surface has a traffic sign;
an LED lighting unit, comprising a plurality of LED components and conducting wires to connect the LED components; said LED lighting unit is fitted and distributed on the marking surface of the indicating plate, so that the traffic sign is in a luminous state;
a speed detecting device, fitted on the functioning section of the vertical frame;
said speed detecting device will detect the speed of the vehicle from predetermined direction;
a warning device, to generate a preset style of warning signal;
an electro-control device, fitted on the functioning section of the vertical frame, connecting and integrating the LED lighting unit, speed detecting device, and warning device, to control the lighting state of the LED lighting unit, and control the warning device to automatically generate a preset warning signal based on the speed detected by the speed detecting device;
a power supply device, electrically connected to the LED lighting unit, speed detecting device, warning device, and the electro-control device, to supply electric power for overall functioning.

2. The device defined in claim 1, wherein the speed detecting device is a speed detecting structure of any kind: induction coil; radar; or laser.

3. The device defined in claim 1, wherein the warning device is any structure of a flashing warning lamp, an illumination lamp, a dynamic message sign displayer, a controllable LED indicating plate, or an alarm.

4. The device defined in claim 1, wherein the power supply device is any kind of cells, municipal electricity, or cells combined with solar power photovoltaie panel.

5. The device defined in claim 1, wherein the functioning section of the vertical frame is configured with an auxiliary sensor, which is electrically connected to the electro-control device; the auxiliary sensor can detect a preset environmental state as the requisite for the speed detecting device to execute the speed detection of the coming vehicle.

6. The device defined in claim 5, wherein the auxiliary sensor is a wind speed sensor.

7. The device defined in claim 1, wherein the luminous traffic sign plate also comprises a wireless transmission module; the wireless transmission module is electrically connected to the electro-control device; when the speed detecting device detects a coming vehicle or the coming vehicle is speeding, the electro-control device will activate the wireless transmission module to transmit a signal to a remote wireless transmission module installed on another luminous traffic sign plate, so that the warning device on this luminous traffic sign plate will generate a preset warning signal.
